(19) United States
(12) Patent Application Publication
(10) Pub. No.: US 2014/0098327 A1
(43) Pub. Date: Apr. 10, 2014

(54) STRUCTURE OF POLARIZER AND LIQUID CRYSTAL PANEL

(71) Applicant: Cheng-Hung Chen, Shenzhen City (CN)

(72) Inventor: Cheng-Hung Chen, Shenzhen City (CN)

(73) Assignee: SHENZHEN CHINA STAR OPTOELECTRONICS TECHNOLOGY CO. LTD., Shenzhen, Guangdong (CN)

(21) Appl. No.: 13/699,695

(22) PCT Filed: Oct. 12, 2012
(86) PCT No.: PCT/CN12/82856

§ 371 Date: Nov. 23, 2012

(30) Foreign Application Priority Data
Oct. 8, 2012 (CN) 201210376941.6

(51) Int. Cl. G02B 5/30; G02F 1/1335

(52) U.S. Cl. CPC G02B 5/30; G02F 1/133528
USPC 349/96; 359/483.01

(57) ABSTRACT

The present invention provides a structure of polarizer and liquid crystal panel. The polarizer includes, from top down, polarizer main body, electrostatic adsorption film and release film. The LC panel includes a polarizer of the structure. Because the polarizer replaces the PSA of the known polarizer with the electrostatic adsorption film, the electrostatic adsorption film uses electrostatic adsorption to attach the polarizer main body to the substrate of the LC panel without using any adhesive. Therefore, when reprocessing is required, no residual adhesive on substrate is left to removal and the cleaning is convenient. Also, electrostatic adsorption film will not damage the polarizer when removed from the substrate so that the polarizer can be reused to effectively save the cost.

The present application claims priority of “STRUCTURE OF POLARIZER AND LIQUID CRYSTAL PANEL”, application No. 201210376941.6 submitted to State Intellectual Property Office, People Republic of China dated Oct. 8, 2012.

### BACKGROUND OF THE INVENTION

1. Field of the Invention

The present invention relates to the field of liquid crystal displaying techniques, and in particular to a structure of polarizer and liquid crystal panel.

2. The Related Arts

A basic structure of a liquid crystal (LC) panel is shown in FIG. 1. The LC panel comprises an upper substrate 2a, a lower substrate 2b, and an LC layer 3 sandwiched between substrates 2a, 2b. An upper polarizer 1a is attached to the upper substrate 2a and a lower polarizer 1b is attached to the lower substrate 2b. The structure of upper polarizer 1a and the lower polarizer 1b is shown in FIG. 2. The structure comprises polarizer main body, pressure sensitive adhesive (PSA) and release film. During the polarizer attachment process of the LC panel process, the release film of the polarizer is first removed and then the exposed PSA of the polarizer is used to attach the main body of the polarizer to the upper substrate 2a or lower substrate 2b in FIG. 1.

As aforementioned, the polarizer of the known technique is attached to the substrate by adhesive sensitive to the pressure. Therefore, when reprocessing is required for the polarizer, the residual adhesive on the substrate must be cleaned during the polarizer removal. In addition, most polarizers are often damaged during the removal because of the PSA and cannot be reused for reattachment. As the cost of the polarizer is a major part of the cost of LC panel, the non-reusability greatly increases the LC panel cost as well as waste of resource.

### SUMMARY OF THE INVENTION

To address the above technique issues, the present invention provides a structure of polarizer, which comprises, from top down, a polarizer main body, an electrostatic adsorption film and a release film; wherein the polarizer main body is an extraordinary light polarization polarizer, or the polarizer main body is an ordinary light polarization polarizer.

Correspondingly, the present invention provides a liquid crystal panel, which comprises: an upper substrate, a lower substrate, a liquid crystal (LC) layer, an upper polarizer, and a lower polarizer; the LC layer being sandwiched between the upper substrate and the lower substrate; the upper polarizer being adhered to the upper substrate and the lower polarizer being adhered to the lower substrate; wherein the upper polarizer and the lower polarizer having the structure of, from top down, a polarizer main body, an electrostatic adsorption film and a release film.

According to a preferred embodiment of the present invention, the polarizer main body of the upper polarizer and the polarizer main body of the lower polarizer are both an extraordinary light polarization polarizer.

According to a preferred embodiment of the present invention, the polarizer main body of the upper polarizer and the polarizer main body of the lower polarizer are both an ordinary light polarization polarizer.

According to a preferred embodiment of the present invention, the polarizer main body of the upper polarizer is an extraordinary light polarization polarizer and the polarizer main body of the lower polarizer is an ordinary light polarization polarizer.

According to a preferred embodiment of the present invention, the polarizer main body of the upper polarizer is an ordinary light polarization polarizer and the polarizer main body of the lower polarizer is an extraordinary light polarization polarizer.

According to a preferred embodiment of the present invention, the upper polarizer is adhered to outer side of the upper substrate and the lower polarizer is adhered to outer side of the lower substrate.

According to a preferred embodiment of the present invention, the upper polarizer is adhered to inner side of the upper substrate and the lower polarizer is adhered to inner side of the lower substrate.

According to a preferred embodiment of the present invention, the upper polarizer is adhered to outer side of the upper substrate and the lower polarizer is adhered to inner side of the lower substrate.

According to a preferred embodiment of the present invention, the upper polarizer is adhered to inner side of the upper substrate and the lower polarizer is adhered to outer side of the lower substrate.

The efficacy of the present invention is that to be distinguished from the state of the art. The present invention provides a structure of polarizer and liquid crystal panel comprising the polarizer. Because the polarizer replaces the PSA of the known polarizer with the electrostatic adsorption film, the electrostatic adsorption film uses electrostatic adsorption to attach the polarizer main body to the substrate of the LC panel without using any adhesive. Therefore, when reprocessing is required, no residual adhesive on the substrate is left to removal and the cleaning is convenient. In addition, electrostatic adsorption film will not damage the polarizer when removed from the substrate so that the polarizer can be reused to effectively save the cost.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a known liquid crystal panel;

FIG. 2 is schematic view showing the structure of a known polarizer;

FIG. 3 is schematic view showing the structure of a polarizer according to the present invention;

FIG. 4 is a schematic view showing the structure of the first embodiment of a liquid crystal panel according to the present invention;

FIG. 5 is a schematic view showing the structure of the second embodiment of a liquid crystal panel according to the present invention;

FIG. 6 is a schematic view showing the structure of the third embodiment of a liquid crystal panel according to the present invention; and

FIG. 7 is a schematic view showing the structure of the fourth embodiment of a liquid crystal panel according to the present invention.

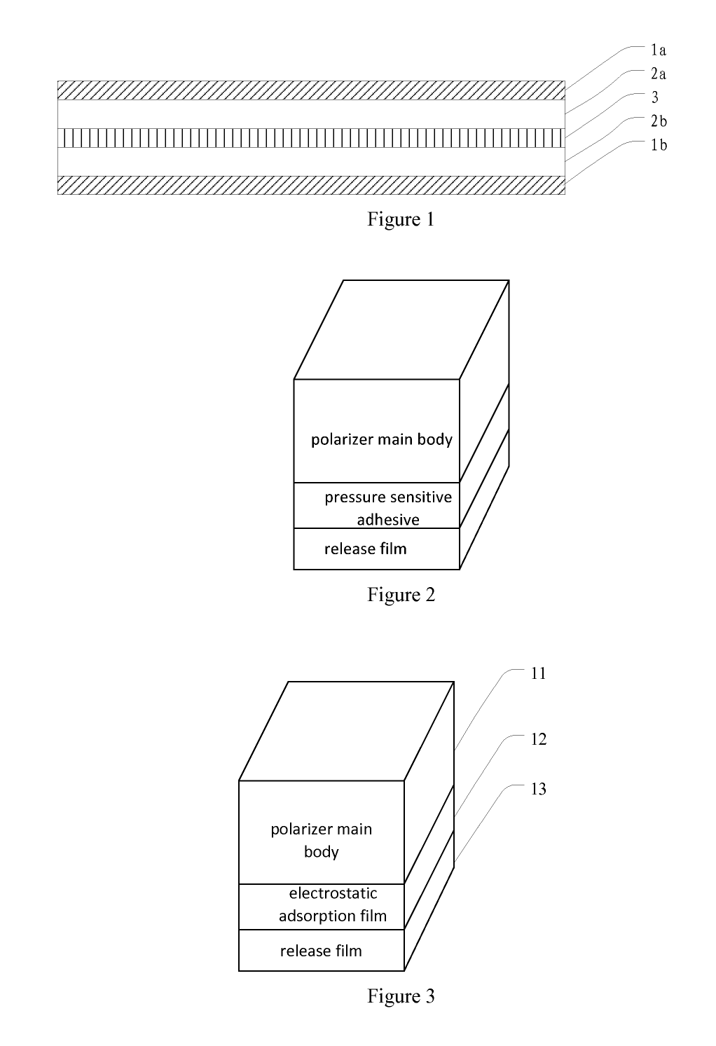

### DETAILED DESCRIPTION OF THE PREFERRED EMBODIMENTS

Referring to FIG. 3, FIG. 3 is schematic view showing the structure of a polarizer according to the present invention, which comprises, to top down, a polarizer main body 11, an electrostatic adsorption film 12 and a release film 13.

The electrostatic adsorption film 12 is located between polarizer main body 11 and release film 13. During the polarizer attachment process of the LC panel cell process, the release film 13 of the polarizer is first removed and the exposed electrostatic adsorption film 12 of the polarizer is used to attach the polarizer main body 11 to the upper substrate and the lower substrate of the LC panel.

The electrostatic adsorption film 12 used in the present invention is not coated with adhesive and depends only on the electrostatic to adsorb to the object to provide protection. The electrostatic adsorption film 12 is often applied to surfaces sensitive to adhesive or glue, such as, glass, lens, high transmittance plastic, acrylic and so on. The electrostatic on the outer surface of electrostatic adsorption film 12 cannot be detected, and the electrostatic adsorption film 12 is a self-adhesive film.

Because the present invention replaces the PSA of the known polarizer with the electrostatic adsorption film, the electrostatic adsorption film uses electrostatic adsorption to attach the polarizer main body to the substrate of the LC panel without using any adhesive. Therefore, when reprocessing is required, no residual adhesive on the substrate is left to removal and the cleaning is convenient. In addition, electrostatic adsorption film will not damage the polarizer when removed from the substrate so that the polarizer can be reused to effectively save the cost.

In a specific embodiment, the polarizer main body 11 is an ordinary light polarization polarizer. The polarization characteristics are: the incident light of ordinary polarization state can pass polarizer main body 11, and the incident light of extraordinary polarization state will be absorbed polarizer main body 11.

In a preferred embodiment of the present invention, the polarizer main body 11 is an extraordinary light polarization polarizer, made with organic dye with liquid-crystalline phase. The polarization characteristics are: the incident light of extraordinary polarization state can pass polarizer main body 11, and the incident light of ordinary polarization state will be absorbed polarizer main body 11. The LC panel using extraordinary light polarization polarizer can obtain higher contrast in a larger view angle range so as to improve display quality. Also, the extraordinary light polarization polarizer can tolerate temperature up to 200° C., which is higher than the ordinary light polarization polarizer. The polarizer main body 11 usually has a thickness less than 100 um. Therefore, when disposed in the inner side of the corresponding substrate in LC panel, the polarizer main body 11 will not affect the operating voltage of the LC panel.

Correspondingly, the present invention provides a liquid crystal panel, which comprises: an upper substrate 2a, a lower substrate 2b, a liquid crystal (LC) layer 3, an upper polarizer 1a, and a lower polarizer 1b. The LC layer 3 is sandwiched between the upper substrate 2a and the lower substrate 2b. The upper polarizer 1a is adhered to the upper substrate 2a and the lower polarizer 1b is adhered to the lower substrate 2b.

The upper polarizer and the lower polarizer have the structure of, from top down, a polarizer main body, an electrostatic adsorption film and a release film, wherein the structure of the upper polarizer and the lower polarizer is as shown in FIG. 3.

During the polarizer attachment process of the LC panel cell process, the release film 13 of the polarizer is first removed and the exposed electrostatic adsorption film 12 of the polarizer is used to attach the polarizer main body 11 to the upper substrate and the lower substrate of the LC panel.

In specific embodiments, the polarizer main body 11 of the upper polarizer and the polarizer main body 11 of the lower polarizer can have the following four combinations:

In the first combination, the polarizer main body 11 of the upper polarizer and the polarizer main body 11 of the lower polarizer are both an extraordinary light polarization polarizer.

The LC panel using extraordinary light polarization polarizer can obtain higher contrast in a larger view angle range so as to improve display quality. Also, the extraordinary light polarization polarizer can tolerate temperature up to 200° C., which is higher than the ordinary light polarization polarizer. The polarizer main body 11 usually has a thickness less than 100 um. Therefore, when disposed in the inner side of the corresponding substrate in LC panel, the polarizer main body 11 will not affect the operating voltage of the LC panel.

In the second combination, the polarizer main body 11 of the upper polarizer and the polarizer main body 11 of the lower polarizer are both an ordinary light polarization polarizer.

In the third combination, the polarizer main body 11 of the upper polarizer is an extraordinary light polarization polarizer and the polarizer main body 11 of the lower polarizer is an ordinary light polarization polarizer.

In the fourth combination, the polarizer main body 11 of the upper polarizer is an ordinary light polarization polarizer and the polarizer main body 11 of the lower polarizer is an extraordinary light polarization polarizer.

In the third and the fourth combinations, because the optical pumping of the orthogonal extraordinary light polarization polarizer and ordinary light polarization polarizer is parallel, the leakage of incident light from any angle can be complemented. Therefore, the uses of an extraordinary light polarization polarizer and an ordinary light polarization polarizer for the upper polarizer and the lower polarizer can greatly reduce the leakage in large angle so as to improve the display quality of LC panel.

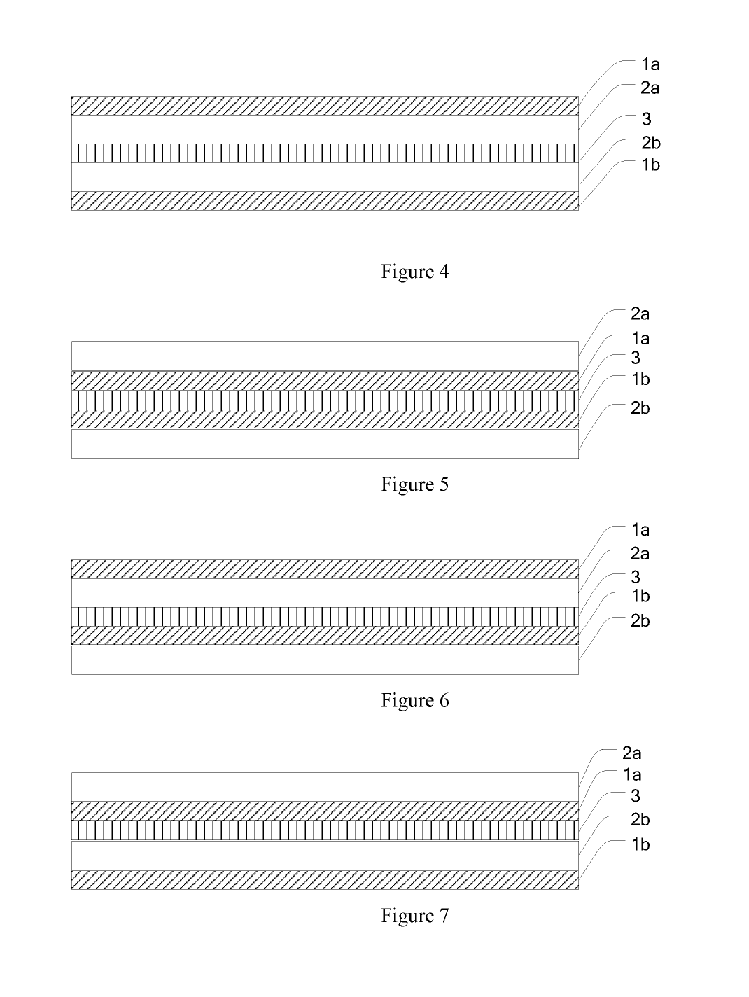

It should be noted that in the LC panel of the present invention, the locations of the upper polarizer and the lower polarizer can vary, specifically, as shown in FIGS. 4-7.

Referring to FIG. 4, FIG. 4 is a schematic view showing the structure of the first embodiment of a liquid crystal panel according to the present invention.

In the instant embodiment, the upper polarizer 1a is adhered to the outer side of the upper substrate 2a, and the lower polarizer 1b is adhered to the outer side of the lower substrate 2b.

Referring to FIG. 5, FIG. 5 is a schematic view showing the structure of the second embodiment of a liquid crystal panel according to the present invention.

In the instant embodiment, the upper polarizer 1a is adhered to the inner side of the upper substrate 2a, and the lower polarizer 1b is adhered to the inner side of the lower substrate 2b.

The disposition of polarizers on the inner side of the substrates can prevent the polarizers from scratching or chemical solution so that the LC panel performs better.

Referring to FIG. 6, FIG. 6 is a schematic view showing the structure of the third embodiment of a liquid crystal panel according to the present invention.

In the instant embodiment, the upper polarizer 1a is adhered to the outer side of the upper substrate 2a, and the lower polarizer 1b is adhered to the inner side of the lower substrate 2b.

Referring to FIG. 7, FIG. 7 is a schematic view showing the structure of the fourth embodiment of a liquid crystal panel according to the present invention.

In the instant embodiment, the upper polarizer 1a is adhered to the inner side of the upper substrate 2a, and the lower polarizer 1b is adhered to the outer side of the lower substrate 2b.

Because the polarizer provided by the present invention replaces the PSA of the known polarizer with the electrostatic adsorption film 12, the electrostatic adsorption film 12 uses electrostatic adsorption to attach the polarizer main body to the substrate of the LC panel without using any adhesive. Therefore, when reprocessing is required, no residual adhesive on the substrate is left to removal and the cleaning is convenient. In addition, electrostatic adsorption film 12 will not damage the polarizer when removed from the substrate so that the polarizer can be reused to effectively save the cost. Furthermore, the polarizers of LC panel provided by the present invention can use extraordinary light polarization polarizer and ordinary light polarization polarizer as polarizer main body to achieve different display quality.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A structure of polarizer, which comprises, from top down, a polarizer main body, an electrostatic adsorption film and a release film.

2. The structure of polarizer as claimed in claim 1, characterized in that the polarizer main body is an extraordinary light polarization polarizer.

3. The structure of polarizer as claimed in claim 1, characterized in that the polarizer main body is an ordinary light polarization polarizer

4. A liquid crystal panel, which comprises: an upper substrate, a lower substrate, a liquid crystal (LC) layer, an upper polarizer, and a lower polarizer; the LC layer being sandwiched between the upper substrate and the lower substrate; the upper polarizer being adhered to the upper substrate and the lower polarizer being adhered to the lower substrate; wherein the upper polarizer and the lower polarizer having the structure of,
from top down, a polarizer main body, an electrostatic adsorption film and a release film.

5. The liquid crystal panel as claimed in claim 4, characterized in that the polarizer main body of the upper polarizer and the polarizer main body of the lower polarizer are both an extraordinary light polarization polarizer.

6. The liquid crystal panel as claimed in claim 4, characterized in that the polarizer main body of the upper polarizer and the polarizer main body of the lower polarizer are both an ordinary light polarization polarizer.

7. The liquid crystal panel as claimed in claim 4, characterized in that the polarizer main body of the upper polarizer is an extraordinary light polarization polarizer and the polarizer main body of the lower polarizer is an ordinary light polarization polarizer.

8. The liquid crystal panel as claimed in claim 4, characterized in that the polarizer main body of the upper polarizer is an ordinary light polarization polarizer and the polarizer main body of the lower polarizer is an extraordinary light polarization polarizer.

9. The liquid crystal panel as claimed in claim 5, characterized in that the upper polarizer is adhered to outer side of the upper substrate and the lower polarizer is adhered to outer side of the lower substrate; or, the upper polarizer is adhered to inner side of the upper substrate and the lower polarizer is adhered to inner side of the lower substrate.

10. The liquid crystal panel as claimed in claim 6, characterized in that the upper polarizer is adhered to outer side of the upper substrate and the lower polarizer is adhered to outer side of the lower substrate; or, the upper polarizer is adhered to inner side of the upper substrate and the lower polarizer is adhered to inner side of the lower substrate.

11. The liquid crystal panel as claimed in claim 7, characterized in that the upper polarizer is adhered to outer side of the upper substrate and the lower polarizer is adhered to outer side of the lower substrate; or, the upper polarizer is adhered to inner side of the upper substrate and the lower polarizer is adhered to inner side of the lower substrate.

12. The liquid crystal panel as claimed in claim 8, characterized in that the upper polarizer is adhered to outer side of the upper substrate and the lower polarizer is adhered to outer side of the lower substrate; or, the upper polarizer is adhered to inner side of the upper substrate and the lower polarizer is adhered to inner side of the lower substrate.

13. The liquid crystal panel as claimed in claim 5, characterized in that the upper polarizer is adhered to outer side of the upper substrate and the lower polarizer is adhered to inner side of the lower substrate; or, the upper polarizer is adhered to inner side of the upper substrate and the lower polarizer is adhered to outer side of the lower substrate.

14. The liquid crystal panel as claimed in claim 6, characterized in that the upper polarizer is adhered to outer side of the upper substrate and the lower polarizer is adhered to inner side of the lower substrate; or, the upper polarizer is adhered to inner side of the upper substrate and the lower polarizer is adhered to outer side of the lower substrate.

15. The liquid crystal panel as claimed in claim 7, characterized in that the upper polarizer is adhered to outer side of the upper substrate and the lower polarizer is adhered to inner side of the lower substrate; or, the upper polarizer is adhered to inner side of the upper substrate and the lower polarizer is adhered to outer side of the lower substrate.

16. The liquid crystal panel as claimed in claim 8, characterized in that the upper polarizer is adhered to outer side of the upper substrate and the lower polarizer is adhered to inner side of the lower substrate; or, the upper polarizer is adhered to inner side of the upper substrate and the lower polarizer is adhered to outer side of the lower substrate.
